(19) United States
(12) Patent Application Publication
(10) Pub. No.: US 2018/0243704 A1
(43) Pub. Date: Aug. 30, 2018

(54) SYSTEM AND METHOD FOR PRODUCING TEMPERATURE STABLE CHEMICAL SOLUTIONS

(71) Applicant: CARGILL, INCORPORATED, Wayzata, MN (US)

(72) Inventors: Robert Scott Koefod, Maple Grove, MN (US); Anthony Quinn Hensley, Ringgold, GA (US)

(21) Appl. No.: 15/967,137

(22) Filed: Apr. 30, 2018

Related U.S. Application Data
(63) Continuation-in-part of application No. PCT/US2016/060337, filed on Nov. 3, 2016.
(60) Provisional application No. 62/250,195, filed on Nov. 3, 2015.

(51) Int. Cl. B01F 15/00; B01F 15/04; B01F 3/08; B01F 1/00; C01D 3/04

(52) U.S. Cl. CPC B01F 15/0022; B01F 15/00285; B01F 15/00396; B01F 15/0087; B01F 2215/0036; B01F 3/088; B01F 1/0038; C01D 3/04; B01F 15/0408

(57) ABSTRACT

A system for automatically producing a brine solution having a concentration of a primary solute that is stable at a defined temperature comprises a controller, a mixing reservoir, a primary solute concentration sensor, and a storage tank. Methods for automatically producing solutions are described.

### RELATED APPLICATIONS

The present Application claims the benefit of provisional Application having Ser. No. 62/250,195, filed on Nov. 3, 2015, which provisional Application is incorporated herein by reference in its entirety.

### FIELD

The invention generally relates to a method and control system to produce aqueous solutions of sodium chloride and optionally one or more additional solutes for deicing applications.

### BACKGROUND

The use of “liquid deicers” is a very common practice in modern winter road and pavement maintenance. The term “liquid deicer” used herein refers generally to aqueous solutions of freeze-point depressant chemicals used to assist in the removal of snow, ice, and freezing precipitation from a pavement surface. There are various ways that such chemicals are used which include but are not necessarily limited to: 1) “deicing”—the application of a chemical to an existing accumulation of snow or ice on a pavement; 2) “anti-icing”—the application of a chemical to a pavement before a winter precipitation event occurs; and 3) “pre-wetting”—the application of an aqueous chemical solution to solid rock salt before it is applied to a pavement. While different terms are used to describe various ways that winter maintenance chemicals are applied, for the purposes of this disclosure “liquid deicer” is intended to generically refer to any aqueous solution used to assist in the removal of snow, ice, or other freezing precipitation from a pavement surface by any of various application methods.

Because of its low cost, ready availability, and high effectiveness, the most commonly used liquid deicers are simple brines of rock salt (sodium chloride). However, at lower temperatures (below about 15° F.) sodium chloride becomes a less effective ice melting agent and alternative chemicals are often used such as calcium chloride and magnesium chloride. While solutions of calcium chloride and magnesium chloride are used as direct application anti-icers and as pre-wetting agents for salt, an increasingly popular practice is to blend magnesium chloride, calcium chloride, or other performance enhancing additives (such as various organic based performance enhancers and corrosion inhibitors) with salt brine. This is often a more efficient and economical way to extract the most value from the more expensive chemicals. These are sometimes referred to as “hot mixes.” An example of a typical “hot mix” is a blend of 80% sodium chloride brine (where the sodium chloride brine contains 23.3% NaCl) and 20% magnesium chloride brine (where the magnesium chloride brine contains 26% MgCl₂).

Control of the concentration of liquid deicers is important because there are two competing factors at play. On the one hand, for the purposes of maximizing ice melting capacity it is desirable to have the highest concentration of chemicals possible, especially to maximize performance in the colder temperature ranges where deicer liquids are most useful. But on the other hand, high concentration solutions often tend to precipitate at cold temperatures. Formation of precipitates in liquid deicers is problematic. It leads to accumulation of solids in storage tanks and can cause lines and spray nozzles to clog. Therefore, sodium chloride brines are often prepared at a specific concentration for use as deicing liquids to avoid this. Sodium chloride deicer liquids are often prepared at a concentration of 23.3% NaCl. This is the eutectic concentration of NaCl in water and therefore provides the lowest stable storage temperature at which the brine will remain free from precipitate (−6° F.). If higher temperatures are anticipated, higher concentration sodium chloride brines can be made.

Most commonly, winter maintenance professionals make their own sodium chloride brine by dissolving rock salt in water. There is a range of commercial brine makers available to accomplish this. Because of the importance of brine concentration control, as described above, some brine makers (for example the type disclosed by Hildreth et. al. in U.S. Patent Application 2013/0094324 A1) are automated so the user can simply select the desired concentration and the brine maker will produce it. This is a useful feature and greatly increases the speed, ease, and efficiency of brine making as it spares the user the need to make a brine, analyze it, calculate the amount of dilution water needed for the desired concentration, add the dilution water, analyze the brine again, etc. However, as useful as this is, the currently available brine makers require a user to know the concentration of chemical needed for a given temperature. To determine this, the user must consult phase diagrams for the given solute system. While this is relatively easy for a single solute brine, such as a plain sodium chloride liquid deicer, it rapidly becomes more complex as the number of solutes increases, such as in various “hot mix” blends. Users will often not have phase diagrams available for the multi-component aqueous solutions they wish to make as deicer solutions and will have to make “best guesses” or estimates, which may lead to errors and resulting problems with precipitation in their deicing liquids or increased costs due to the use of higher cost additives. Thus, the present disclosure describes an improved system for making deicing liquids which address some of the challenges of brine precipitation and cost of additive use in trying to maximize ice melting capacity.

### SUMMARY

This summary is provided to introduce a selection of concepts in a simplified form that are further described below in the Detailed Description. The summary is not intended to identify key features or essential features of the claimed subject matter. The present disclosure describes an improved system for making deicing liquids which will automatically calculate an optimum concentration of additives for a selected temperature of the deicing liquid or brine. In one embodiment the brine making system will produce a blend with the optimum NaCl concentration required for a particular desired blend of chemicals for a selected storage temperature to maximize ice melting capacity while preventing precipitation. In another embodiment, the system will produce a brine solution from a blend of chemicals to achieve a desired level of performance (such as ice melting capacity or ice melting rate) at a selected temperature.

The present application relates to an apparatus and method and control system to produce temperature optimized solutions of one or more solutes. More particularly, the application relates to an apparatus and method and control system to produce aqueous solutions of sodium chloride and optionally one or more additional solutes (such as calcium chloride, magnesium chloride, or other performance enhancers) for use as liquid deicers, anti-jeers, and pre-wetting agents that will be optimized for a given temperature. In one embodiment, brine additive concentrations are optimized to prevent precipitation of solids at a given temperature while maximizing ice melting capacity at a selected temperature. In another embodiment, brine additive concentrations are optimized to achieve a desired level of performance, such as ice melting capacity or ice melting rate, at a selected temperature.

While multiple embodiments are disclosed, other embodiments of the invention will become apparent to those skilled in the art from the following detailed description, which shows and describes illustrative embodiments of the invention. The invention is capable of being modified in various aspects, all without departing from the spirit and scope of the invention. Accordingly, the drawings and detailed descriptions are to be regarded as illustrative in nature and not restrictive.

### BRIEF DESCRIPTION OF THE DRAWINGS

FIG. 1 illustrates a system having a controller for making a solution containing one or more solutes at an optimized concentration for a user's application in accordance with certain aspects of the invention; and

FIG. 2 is a flow chart that illustrates a process of making a solution using the system of FIG. 1 utilizing a controller programmed to make the solution containing one or more solutes at an optimized concentration for maximum ice melting effectiveness while being stable to precipitation at a selected temperature in accordance with aspects of the invention.

### DETAILED DESCRIPTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

The application relates to an apparatus and method and control system for automatically making aqueous solutions of one or more solutes with an optimum concentration to maximize performance while avoiding precipitation at a given temperature. More particularly, it relates to a brine making system for use in making aqueous deicing liquids containing sodium chloride optionally with other performance enhancing chemicals such as magnesium chloride, calcium chloride, or organic based performance enhancers and corrosion inhibitors, which will have the maximum concentration of sodium chloride possible while avoiding precipitation of any solids at a selected temperature. The system includes a human machine interface (HMI) in which the user inputs a desired composition of deicer liquid components and a desired storage temperature for the liquid. The system includes a Programmable Logic Controller (PLC) which identifies the maximum sodium chloride concentration that will be stable to precipitation at a selected temperature and concentration of other performance enhancing additives from an internal database. The system includes an area where sodium chloride and water are mixed and a concentration sensor used to determine if the solution needs to be made more concentrated or dilute. When the sodium chloride concentration is within a given tolerance of the calculated optimum, the solution is diverted to an exit port. The system also includes a controlled pumping system to deliver quantities of other optional liquid additives (such as solutions of calcium chloride or magnesium chloride) to the exit port to achieve the selected ratio of additives to sodium chloride brine in the final mixture.

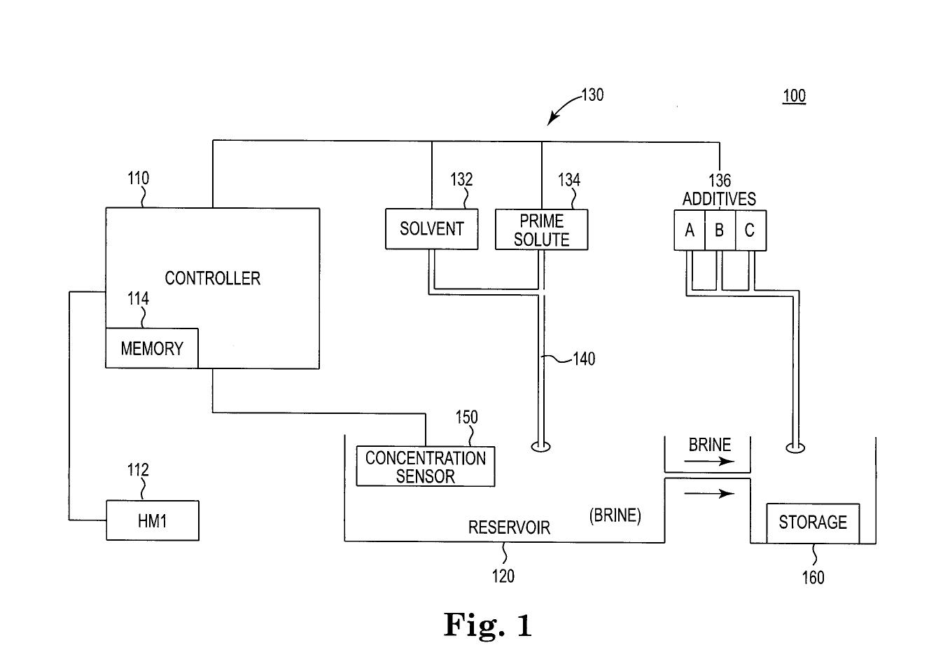

Referring now to FIG. 1, there is illustrated a chemical solution blending system 100 that includes a controller 110 having a human machine interface 112 (a work station; wireless smart device; input panel, etc.) operatively coupled to the controller for receiving inputs from a user and a memory portion 114 configured to receive data associated with the amount of chemical solution produced for each primary solute and additive combination. System 100 also includes a mixing reservoir 120, a plurality of blending solutes 130, at least one conduit system 140 for the solutes to be directed to reservoir 120; a concentration sensor 150 disposed within reservoir 120 that is communicatively coupled to controller 110 and at least one storage tank 160 operatively coupled to reservoir 120 that receives the brine solution at rate of about 80 gallons per minute in this example. The various additives A, B and C are added into tank 160 at a rate of about 20 gallons per minute in this example.

In one example embodiment of system 100 for use in connection with generating a brine solution for de-icing applications, system 100 is configured to automatically produce a brine solution having a concentration of a primary solute, in this case salt or sodium chloride, which is stable at a defined temperature. In this example embodiment, system 100 includes controller 110 configured to receive a storage temperature of a primary solute (from primary solute holder 134) in the brine solution as a first input from a user at human interface 112 and to receive a second input from interface 112 of an identity of at least one additive (from an additive holder 136) and a concentration of the additive to be blended with the primary solute solution. Controller 110 is programmed to generate a chemical brine solution composition in reservoir 120 comprised of the primary solute and in-line mixing of the one additive so that the solution composition has concentrations of each of the primary solute and the selected additive to correspond with the storage temperature that was input by the user and to prevent the primary solute from precipitating or crystallizing. In this example embodiment, mixing reservoir 120 receives the primary solute and a solvent from solvent holder 132 (via a command from controller 110) to form therein a chemical solution. Primary solute concentration sensor 150 located or disposed within mixing reservoir 120 measures the concentration of the primary salute in the chemical solution and then sensor 150 communicates (either hardwire or wirelessly) a concentration of the primary solute in the chemical slurry to controller 110. Controller 110 then verifies that the concentration of the primary solute is within a target concentration determined by a blending program in the controller. Storage tank 160 receives the brine solution (at a flow rate of about 80 gallons per minute, in this example) after being diverted by controller 110 from mixing reservoir 120 and receives one or more additive(s) A, B and C 136 at a quantity and a rate determined by the controller 110 program for the chemical brine solution.

In another embodiment, a sensor is included in storage tank 160 so as to measure a discharge temperature as the brine solution is coming out of tank 160. This feature can serve as additional feedback as to how the programmed temperature for the initial brine solution has changed when compared to the actual discharge temperature as the brine solution is being used. In a related embodiment, controller 110 is configured to receive a plurality of inputs from the user via interface 112 of additive identities and associated additive concentrations. In this example embodiment, memory portion 114 receives data associated with the amount of brine solution produced for each primary solute and additive A, B or C combination.

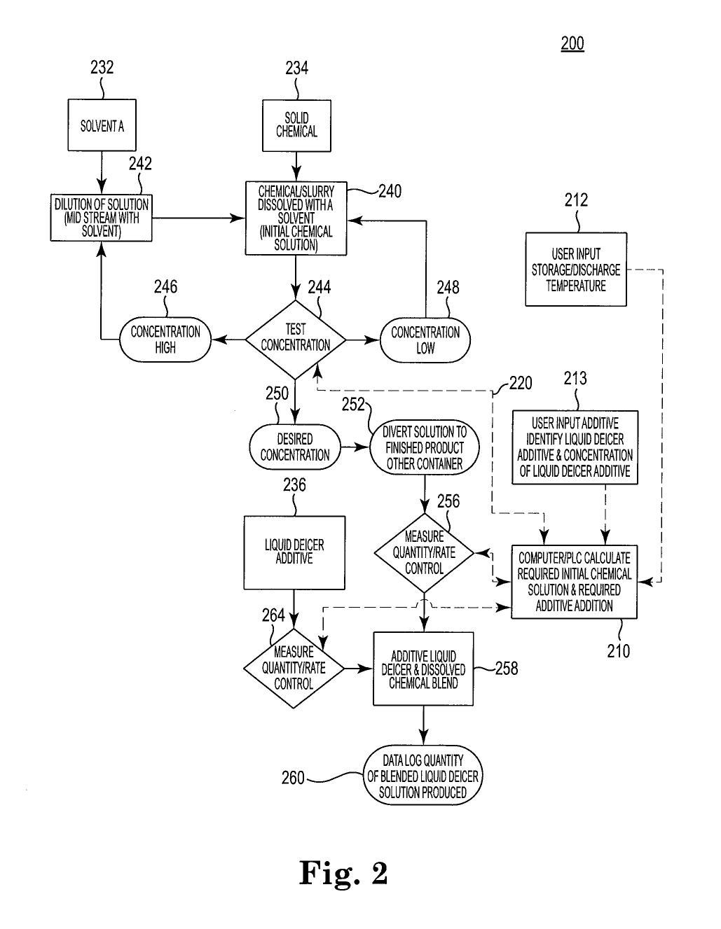

Referring now to FIG. 2, there is illustrated a flowchart of a method 200 for automatically producing a brine solution having a concentration of a primary solute that is stable at a defined temperature. In this example embodiment, the blending process utilizes a controller programmed to make the solution containing one or more solutes at an optimized concentration for maximum ice melting effectiveness while being stable to precipitation at a selected temperature. Method or blending process 200 implements a brine solution process using a system as in FIG. 100, which includes a controller 210 with a brine blending program, a user input interface 212 for inputting at least the brine storage temperature (and optionally the discharge temperature in other applications). A separate user interface 213 (or the same interface 212 can be used) is used to input the additive(s) identity liquid deicer additive and concentration of liquid deicer additive. In this example embodiment, controller 210 (or PLC or other controller device) is programmed to calculate required initial chemical solution and required additive additions.

In this example embodiment, solvent A and solid chemical (primary solute, such as sodium chloride) are held in tanks or bins 232 and 234, respectively. At the start of the blending process, the user inputs at step 212 into controller 210 a storage temperature of a primary solute in the brine solution and then at step 213 inputs into controller 210 an identity of at least one additive and a concentration of the additive in the brine solution. Then at step 240, controller 210 is initiated to generate a chemical brine solution composition with the primary solute and solvent A (or at least one additive) with the solution composition having concentrations of each of the primary solute and solvent A corresponding with the user selected storage temperature. After mixing the primary solute with solvent A to form a chemical solution, at step 244 the concentration of the solid chemical in the chemical solution is tested by measuring the chemical solution with a primary solute concentration sensor (such as sensor 150 of system 100) to verify that the concentration of the primary solute is within a target concentration.

In flowchart 200, a dashed line 220 illustrates the concentration sensor communicating a concentration of the primary solute in the chemical solution to controller 210 and controller 210 compares the primary solute concentration of the brine solution to a target concentration of the primary solute. At step 246, controller 210 determines that the concentration is high hence a diluting of the brine solution with the solvent (move to step 242) if the primary solute in the brine solution is over-concentrated. Controller 210 drives the process to step 248 where the concentration is low and there is a need to increase the concentration of the primary solute in the brine or chemical solution if the primary solute in the brine solution is under-concentrated. At step 250, if the primary solute concentration in the brine solution is within tolerance of the target concentration for the primary solute, process 200 automatically diverts the brine solution to a storage tank at step 252. At step 256 the liquid deicer additive (step 236) is mixed into the brine solution of the storage tank at a quantity and at a rate (steps 256) determined by controller 210 for the chemical brine solution composition. At step 264 the brine solution is optionally measured another time and checked with controller 210 and adjusted if need be. Finally, at step 260 the brine solution from the storage tank has its data logged in to controller 210 (quantity of blended liquid deicer solution produced).

In a related embodiment, the blending method is modified to input into the controller the identity of a plurality of additives and the concentration of each of the additives. In yet another related embodiment, the step of automatically diluting the solution also includes adding solvent to the chemical solution and wherein automatically increasing the concentration of the chemical slurry includes adding primary solute to the chemical solution. In yet another related embodiment, in-line mixing occurs of the at least one additive into the brine solution at a quantity and at a rate determined by the controller for the chemical brine solution composition and then diverting a final brine solution to another container.

In yet another related embodiment, a method is provided for automatically producing a final chemical solution having a concentration of a primary solute that is stable at a defined temperature, the method including the steps of inputting into a controller a storage temperature of a primary solute in the solution and an identity of at least one additive and a concentration of the additive to be blended with the primary solute solution. The controller is initiated to generate the chemical solution composition with the primary solute and the at least one additive, the solution composition having concentrations of each of the primary solute and the at least one additive configured to correspond with the storage temperature. Next step in process is mixing the primary solute with a diluting agent to form an initial chemical solution or slurry and measuring the initial chemical slurry with a primary solute concentration sensor to verify that the concentration of the primary solute is within a target concentration, the concentration sensor communicating a concentration of the primary solute in the initial chemical solution to the controller. Further in the blending process, the primary solute concentration of the chemical solution is compared to a target concentration of the primary solute. The initial chemical solution is then diluted with the diluting agent if the primary solute in the solution is over-concentrated and the concentration of the primary solute in the chemical solution is increased if the primary solute in the solution is under-concentrated. The initial chemical solution is then diverted to a storage tank if the primary solute concentration in the chemical solution is within tolerance of the target concentration for the primary solute. The at least one additive is then mixed into the initial chemical solution at a quantity and at a rate determined by the controller for the final chemical solution composition. In a related embodiment, in-line mixing of the at least one additive into the initial chemical solution at a quantity and at a rate determined by the controller for the final chemical solution composition occurs before diverting the final chemical solution to another container. This method is useful for generating chemical solutions such as, but not limited to, gasoline mixtures having different additives to boost octane or handle extra cold or hot weather; or coolant mixtures to prevent freezing lines at different or lower temperatures and uses.

The following patents and publications are incorporated by reference in their entireties: U.S. Pat. Nos. 7,810,987; and 8,251,569.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

We claim:

1. A method for automatically producing a brine solution having a concentration of a primary solute that is stable at a defined temperature, the method comprising the steps of:
inputting into a controller a storage temperature of a primary solute in the brine solution;
inputting into the controller an identity of at least one additive and a concentration of the additive in the brine solution;
initiating the controller to generate a chemical brine solution composition with the primary solute and the at least one additive, the solution composition having concentrations of each of the primary solute and the at least one additive corresponding with the storage temperature;
mixing the primary solute with a solvent to form a chemical solution and measuring the chemical solution with a primary solute concentration sensor to verify that the concentration of the primary solute is within a target concentration, the concentration sensor communicating a concentration of the primary solute in the chemical solution to the controller;
comparing the primary solute concentration of the brine solution to a target concentration of the primary solute, diluting the brine solution with the solvent if the primary solute in the brine solution is over-concentrated, increasing the concentration of the primary solute in the brine solution if the primary solute in the brine solution is under-concentrated;
automatically diverting the brine solution to a storage tank if the primary solute concentration in the brine solution is within tolerance of the target concentration for the primary solute; and
mixing the at least one additive into the brine solution at a quantity and at a rate determined by the controller for the chemical brine solution composition.

2. The method of claim 1, further comprising inputting into the controller the identity of a plurality of additives and the concentration of each of the additives.

3. The method of claim 1, wherein automatically diluting the solution comprises adding solvent to the chemical solution and wherein automatically increasing the concentration of the chemical slurry comprises adding primary solute to the chemical solution.

4. The method of claim 1, further comprising data logging quantity of brine solution produced.

5. The method of claim 1 further comprising in-line mixing the at least one additive into the brine solution at a quantity and at a rate determined by the controller for the chemical brine solution composition and then diverting a final brine solution to another container.

6. The method of claim 1 further comprising diverting a final brine solution to another container and then adding the at least one additive into the brine solution at a quantity and at a rate determined by the controller for the chemical brine solution composition.

7. A system for automatically producing a brine solution having a concentration of a primary solute that is stable at a defined temperature, the system comprising:
a controller configured to receive a storage temperature of a primary solute in the brine solution as a first input, the controller configured to receive a second input comprised of an identity of at least one additive and a concentration of the additive to be blended with the primary solute solution, the controller further configured to generate a chemical brine solution composition comprised of the primary solute and in-line mixing of the at least one additive, the solution composition having concentrations of each of the primary solute and the at least one additive configured by the controller to correspond with the storage temperature and prevent primary solute precipitation;
a mixing reservoir configured to receive the primary solute and a solvent to form therein a chemical solution;
a primary solute concentration sensor disposed within the mixing reservoir and configured to measure the concentration of the primary solute in the chemical solution, the concentration sensor communicating a concentration of the primary solute in the chemical slurry to the controller, wherein the controller is configured to verify that the concentration of the primary solute is within a target concentration; and
a storage tank for receiving the brine solution after being diverted by the controller from the mixing reservoir, the storage tank further configured to receive the at least one additive at a quantity and a rate determined by the controller for the chemical brine solution.

8. The system of claim 7, further comprising a human machine interface operatively coupled to the controller for receiving the first and second inputs from a user.

9. The system of claim 7, wherein the controller is further configured to receive a plurality of inputs comprised of additive identities and associated additive concentrations.

10. The system of claim 9, wherein the controller is further comprises a memory portion for receiving data associated with the amount of brine solution produced for each primary solute and additive combination.

11. A method for automatically producing a final chemical solution having a concentration of a primary solute that is stable at a defined temperature, the method comprising the steps of:
inputting into a controller a storage temperature of a primary solute in the solution;
inputting into the controller an identity of at least one additive and a concentration of the additive to be blended with the primary solute solution;
initiating the controller to generate an initial chemical solution composition with the primary solute and the at least one additive, the solution composition having concentrations of each of the primary solute and the at least one additive configured to correspond with the storage temperature;
mixing the primary solute with a diluting agent to form an initial chemical solution or slurry and measuring the initial chemical solution or slurry with a primary solute concentration sensor to verify that the concentration of the primary solute is within a target concentration, the concentration sensor communicating a concentration of the primary solute in the initial chemical slurry to the controller;
comparing the primary solute concentration of the initial chemical solution to a target concentration of the primary solute;
diluting the initial chemical solution with the diluting agent if the primary solute in the solution is over-concentrated;
increasing the concentration of the primary solute in the initial chemical solution if the primary solute in the solution is under-concentrated;
diverting the solution to a storage tank if the primary solute concentration in the initial chemical solution is within tolerance of the target concentration for the primary solute; and
mixing the at least one additive into the initial chemical solution at a quantity and at a rate determined by the controller for the final chemical solution composition.

12. The method of claim 11 further comprising in-line mixing the at least one additive into the initial chemical solution at a quantity and at a rate determined by the controller for the chemical solution composition before diverting e final chemical solution to another container.

13. A method for automatically producing a brine solution containing sodium chloride as a primary solute and secondary solutes at a concentration to achieve a desired ice melting capacity or ice melting rate at a defined temperature, the method comprising the steps of:
inputting into a controller a desired brine use temperature and a desired performance value consisting of one of an ice melting capacity or an ice melting rate;
inputting into the controller an identity of at least one additive as the secondary solute;
initiating the controller to generate a chemical brine solution composed of sodium chloride solute and the at least one additive, the chemical brine solution having concentrations of each of the at least one additive and sodium chloride to achieve e selected performance value at the selected brine use temperature;
mixing the sodium chloride with water to form a chemical solution and measuring the chemical solution with a concentration sensor to verify that the concentration of the sodium chloride is within a target concentration, the concentration sensor communicating a concentration of the sodium chloride solute in the chemical solution to the controller;
comparing a sodium chloride concentration of the brine solution to a target concentration of the sodium chloride solute, diluting the brine solution with the water if the sodium chloride in the brine solution is over-concentrated and increasing the concentration of the sodium chloride in the brine solution if brine solution is under-concentrated;
automatically diverting the brine solution to a storage tank if the sodium chloride concentration in the brine solution is within tolerance of the target concentration; and
mixing the at least one additive into the brine solution at a quantity and at a rate determined by the controller for the chemical brine solution composition.
